(19) United States
(12) Patent Application Publication
(10) Pub. No.: US 2025/0198673 A1
(43) Pub. Date: Jun. 19, 2025

(54) REFRIGERATION CYCLE DEVICE

(71) Applicant: DENSO CORPORATION, Kariya-city (JP)

(72) Inventors: Kengo SUGIMURA, Kariya-city (JP); Satoshi ITO, Kariya-city (JP)

(21) Appl. No.: 19/069,524

(22) Filed: Mar. 4, 2025

Related U.S. Application Data
(63) Continuation of application No. PCT/JP2023/029280, filed on Aug. 10, 2023.

(30) Foreign Application Priority Data
Sep. 7, 2022 (JP) 2022-142136

(51) Int. Cl. F25B 40/06; F25B 41/20; F25B 43/00; F25B 49/02

(52) U.S. Cl. CPC F25B 40/06; F25B 41/20; F25B 43/006; F25B 49/02; F25B 2400/04; F25B 2600/2501

(57) ABSTRACT

A refrigeration cycle device includes components that manage refrigerant. It has a compressor that draws in and compresses refrigerant, which then passes through a radiator to dissipate heat. A decompressor reduces the refrigerant's pressure before it enters an evaporator, where it evaporates. An accumulator separates the refrigerant into gas and liquid phases and discharges the gas-phase refrigerant. A superheater then superheats this gas-phase refrigerant using a hotter heat medium. The device also features a cooling heat exchanger that cools an object via heat exchange with the heat medium. A heat medium circuit ensures the medium circulates through the evaporator, superheater, and cooling heat exchanger. The evaporator uses the heat medium to evaporate the decompressed refrigerant.

### CROSS REFERENCE TO RELATED APPLICATIONS

The present application is a continuation application of International Patent Application No. PCT/JP2023/029280 filed on Aug. 10, 2023, which designated the U.S. and claims the benefit of priority from Japanese Patent Application No. 2022-142136 filed on Sep. 7, 2022. The entire disclosures of all of the above applications are incorporated herein by reference.

### TECHNICAL FIELD

The present disclosure relates to a refrigeration cycle device including an accumulator.

### BACKGROUND

A refrigeration cycle device has an inlet of an accumulator connected to an outlet of an evaporator.

### SUMMARY

According to at least one embodiment, a refrigeration cycle device includes several components that work together to manage refrigerant. The device has a compressor that draws in refrigerant and discharges it after compression. A radiator dissipates heat from the discharged refrigerant. A decompressor then reduces the pressure of the refrigerant after it has passed through the radiator. An evaporator subsequently evaporates the refrigerant after decompression. The device also includes an accumulator, which separates the refrigerant into gas and liquid phases after evaporation and discharges the refrigerant in its gas phase. A superheater superheats the gas-phase refrigerant discharged from the accumulator by exchanging heat with a medium hotter than the refrigerant. Additionally, a cooling heat exchanger cools an object by facilitating heat exchange between the heat medium and the object. A heat medium circuit is formed to ensure the medium circulates through the evaporator, superheater, and cooling heat exchanger. The evaporator performs heat exchange with the heat medium to evaporate the refrigerant after it has been decompressed by the decompressor.

### BRIEF DESCRIPTION OF DRAWINGS

The details of one or more embodiments are set forth in the accompanying drawings and the description below. Other features and advantages will be apparent from the description and drawings, and from the claims.

The foregoing and other objects, features, and advantages of the present disclosure will become more apparent from the following detailed description with reference to the accompanying drawings.

FIG. 1 is an overall configuration diagram of a vehicle air-conditioning device according to a first embodiment.

FIG. 2 is a schematic configuration diagram of a heat exchanger unit according to the first embodiment.

FIG. 3 is a schematic configuration diagram of an inside air conditioning unit according to the first embodiment.

FIG. 4 is a block diagram illustrating a controller of the vehicle air-conditioning device according to the first embodiment.

FIG. 5 is a Mollier diagram illustrating a change in a state of a refrigerant in a refrigeration cycle device according to a first embodiment.

FIG. 6 is an overall configuration diagram of a vehicle air-conditioning device according to a second embodiment.

FIG. 7 is a schematic configuration diagram of a portion of a refrigeration cycle device according to a second embodiment.

FIG. 8 is an overall configuration diagram of a vehicle air-conditioning device according to a third embodiment.

### DETAILED DESCRIPTION

To begin with, examples of relevant techniques will be described.

A refrigeration cycle device according to a comparative example has an inlet of an accumulator connected to an outlet of an evaporator. The accumulator serves as a gas-liquid separator that performs gas-liquid separation of refrigerant flowing into the accumulator and accumulates an excess amount of the refrigerant in the cycle.

In the comparative example, refrigeration oil is mixed with the refrigerant, and a portion of the refrigeration oil circulates in the cycle along with the refrigerant to ensure compressor lubricity. Therefore, it operates so that the refrigerant at the evaporator outlet has a certain amount of dryness.

In the comparative example, although the refrigerant at the evaporator outlet has a certain amount of dryness, superheat of the refrigerant at the evaporator outlet is not controlled. Contrary to this, in a refrigeration cycle device with a receiver on an outlet of a radiator, superheat of refrigerant at an outlet of an evaporator is controlled. The receiver serves as a gas-liquid separator that performs gas-liquid separation of the refrigerant flowing into the receiver into a gas-phase and a liquid-phase and accumulates an excess amount of the refrigerant in the cycle.

In a refrigeration cycle device with a receiver, refrigerant at an evaporator outlet is controlled with a certain amount of superheat, so an enthalpy difference in the evaporator can be large. As a result, cycle performance can be improved.

On the other hand, in the refrigeration cycle device with the accumulator, it is difficult to obtain a large enthalpy difference in the evaporator because the superheat of the refrigerant at the evaporator outlet is not controlled. As a result, the cycle performance improvement is also difficult.

In contrast to the comparative example, according to a refrigeration cycle device of the present disclosure, cycle performance of a refrigeration cycle device with an accumulator can be improved.

According to one aspect of the present disclosure, a refrigeration cycle device includes several components that work together to manage refrigerant. The device has a compressor that draws in refrigerant and discharges it after compression. A radiator dissipates heat from the discharged refrigerant. A decompressor then reduces the pressure of the refrigerant after it has passed through the radiator. An evaporator subsequently evaporates the refrigerant after decompression. The device also includes an accumulator, which separates the refrigerant into gas and liquid phases after evaporation and discharges the refrigerant in its gas phase. A superheater superheats the gas-phase refrigerant discharged from the accumulator by exchanging heat with a medium hotter than the refrigerant. Additionally, a cooling heat exchanger cools an object by facilitating heat exchange between the heat medium and the object. A heat medium circuit is formed to ensure the medium circulates through the evaporator, superheater, and cooling heat exchanger. The evaporator performs heat exchange with the heat medium to evaporate the refrigerant after it has been decompressed by the decompressor.

According to this configuration, the refrigerant flowing out of the accumulator is superheated in the superheater, thereby increasing the enthalpy difference at the low pressure, i.e., in the evaporator and the superheater. Therefore, the cycle performance (COP) can be improved.

Hereinafter, embodiments for implementing the present disclosure are described referring to drawings. In each embodiment, portions corresponding to those described in the preceding embodiment are denoted by the same reference numerals, and overlapping descriptions may be omitted. In a case where only a part of the configuration is described in each embodiment, other embodiments previously described can be applied to other parts of the configuration. It is also possible to partially combine the embodiments even when it is not explicitly described, as long as there is no problem in the combination as well as the combination of the parts specifically and explicitly described that the combination is possible.

### First Embodiment

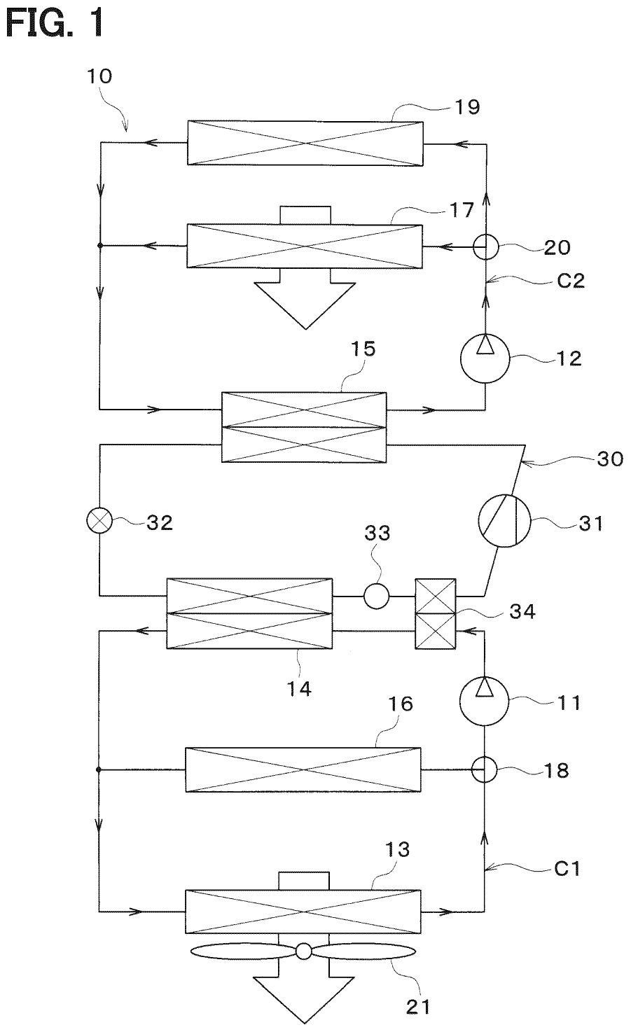

A vehicle air-conditioning device 10 shown in FIG. 1 is used to adjust a space in an interior of a vehicle to a suitable temperature. The vehicle air-conditioning device 10 according to the first embodiment is applied to an electric vehicle in which a vehicle travel driving force is obtained from a traveling electric motor. The electric vehicle of the present embodiment is configured as capable of charging a battery (i.e., in-vehicle battery) mounted on the vehicle with electric power supplied from an external electric power source (i.e., commercial power source) when the vehicle is stopped. As the battery, for example, a lithium-ion battery can be used.

The power stored in the battery may be supplied to the electric motor, and to various devices, which are mounted to the vehicle, such as various electric components in the vehicle air-conditioning device 10 for a vehicle as well.

The vehicle air-conditioning device 10 has a low temperature pump 11, a high temperature pump 12, a low temperature radiator 13, an evaporator 14, a condenser 15, a cooler core 16, a heater core 17, a switching valve 18, a high temperature radiator 19 and a flow control valve 20.

The low temperature pump 11 and the high temperature pump 12 are electrically driven pumps that intake and discharge cooling water (in other words, a heat medium or a coolant water). The cooling water is a fluid serving as a heat medium. In the present embodiment, a cooling water containing at least ethylene glycol, dimethylpolysiloxane, or a nanofluid, or an antifreezing fluid is used as the coolant.

The low temperature radiator 13, the evaporator 14, the condenser 15, the cooler core 16, the heater core 17, and the high temperature radiator 19 are cooling water distribution devices (in other words, heat medium distribution devices).

The low temperature radiator 13 is a coolant-air heat exchanger (in other words, a heat medium-air heat exchanger) that exchanges heat between the cooling water and outside air (i.e., air outside a vehicle compartment). The low temperature radiator 13 is arranged in a front side portion of the vehicle. The low temperature radiator 13 receives the outside air sent from an outside blower 21. An airflow generated during traveling of the vehicle can be applied to the low temperature radiator 13 while the vehicle is traveling.

The outside blower 21 is an outside-air blowing unit that blows the outside air toward the low temperature radiator 13. The outside blower 21 is an electric blower in which a fan is driven by an electric motor.

The evaporator 14 is a low pressure heat exchanger (in other words, a heat medium cooling heat exchanger) that cools the cooling water by performing a heat exchange between a low pressure coolant in a refrigeration cycle 30 and the cooling water. The evaporator 14 is capable of cooling the cooling water to a temperature lower than the temperature of the outside air.

The condenser 15 is a high-pressure heat exchanger (in other words, a heat medium heating heat exchanger) that heats the cooling water by exchanging heat between the high pressure refrigerant of the refrigeration cycle 30 and the cooling water.

The refrigeration cycle 30 is a vapor-compression refrigerator including a compressor 31, the condenser 15, an expansion valve 32, the evaporator 14, an accumulator 33, and a superheater 34. The refrigeration cycle 30 in the present embodiment uses a fluorocarbon refrigerant as a refrigerant, and forms a subcritical refrigeration cycle in which a high-pressure-side refrigerant pressure does not exceed a critical pressure of the refrigerant.

The compressor 31 is an electric compressor driven by power supplied from the battery or a variable capacity compressor driven by a belt. The compressor is configured to draw, compresses, and discharges the refrigerant in the refrigeration cycle 30. The condenser 15 serves as a condenser that is configured to condense the high-pressure refrigerant by performing a heat exchange between the high-pressure refrigerant discharged from the compressor 31 and the cooling water.

The expansion valve 32 serves as a decompressor that is configured to decompress and expand a liquid-phase refrigerant flowing out of the condenser 15. The evaporator 14 is an evaporator that evaporates low-pressure refrigerant by heat exchange between the low-pressure refrigerant decompressed and expanded by the expansion valve 32 and the cooling water. The gas-phase refrigerant evaporated in the evaporator 14 is drawn into and compressed by the compressor 31.

The accumulator 33 is a gas-liquid separator that separates gas and liquid of the refrigerant flowing out of the evaporator 14, allowing the gas phase refrigerant to flow out and storing the liquid phase refrigerant as surplus refrigerant. The superheater 34 is a heat exchanger that superheats the gas-phase refrigerant flowing out of the accumulator 33 by exchanging heat with cooling water.

The cooler core 16 is an air-cooling heat exchanger (in other words, a cooling heat exchanger) that cools air by exchanging the cooling water of a low-temperature cooling water circuit C1 with the air (in other words, a cooling object) that is blown into the vehicle compartment. In the cooler core 16, the cooling water absorbs heat from the air by sensible heat change. That is, in the cooler core 16, the phase of the coolant does not change from the liquid-phase even when the cooling water absorbs heat from the air.

The heater core 17 is a heat exchanger for air heating (in other words, a heating heat exchanger for heat medium dissipation) that heats the air by exchanging the cooling water in a high-temperature cooling water circuit C2 with the air after passing through the cooler core 16. In the heater core 17, the cooling water dissipates heat to the air by sensible heat change. In other words, in the heater core 17, the cooling water remains in the liquid-phase and does not change the phase even if the cooling water dissipates to the air.

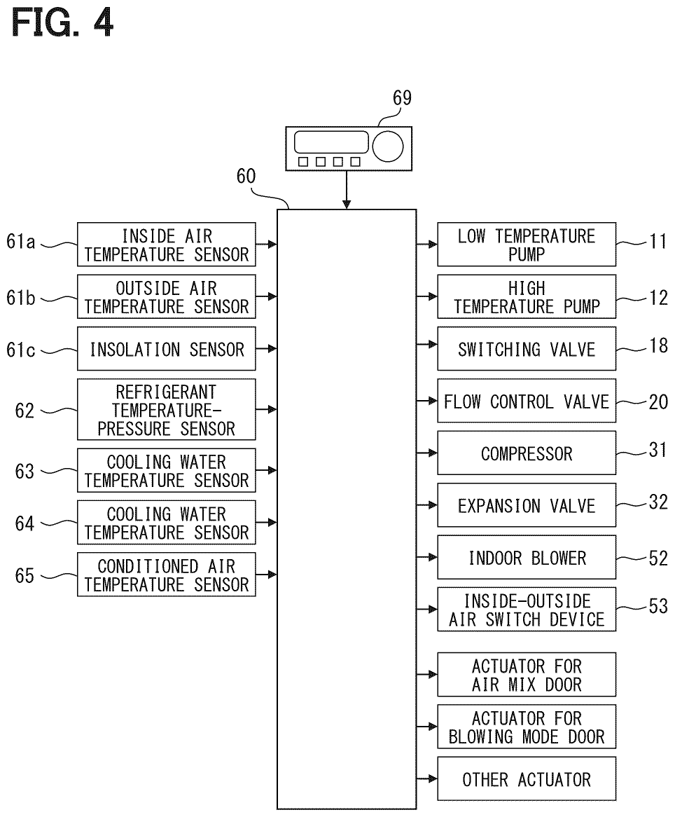

The switching valve 18 is a switching unit that switches the flow of the cooling water to the low temperature radiator 13 and the cooler core 16. The high temperature radiator 19 is a cooling water-external air heat exchanger (in other words, a heat medium-external air heat exchanger) that exchanges heat between the cooling water and the outside air. The flow control valve 20 is a flow rate regulator that adjusts a flow rate of the cooling water to the heater core 17 and the high temperature radiator 19. The switching valve 18 and the flow control valve 20 are control valves controlled by a controller 60 shown in FIG. 4.

As shown in FIG. 1, the evaporator 14, the superheater 34, the low temperature pump 11, the low temperature radiator 13, the cooler core 16, and the switching valve 18 are located in the low-temperature cooling water circuit C1 (in other words, a low temperature heat transfer circuit). The low-temperature cooling water circuit C1 is a cooling water circuit in which low-temperature cooling water (in other words, low-temperature heat medium) circulates in the order of the low temperature pump 11, the superheater 34, the evaporator 14, the low temperature radiator 13, the cooler core 16, and the low temperature pump 11. The cooling water in the low-temperature cooling water circuit C1 flows in parallel through the low temperature radiator 13 and the cooler core 16.

The high temperature pump 12, the condenser 15, the heater core 17, the high temperature radiator 19, and the flow control valve 20 are located in the high-temperature cooling water circuit C2 (in other words, a high temperature heat transfer circuit). The high-temperature cooling water circuit C2 is a cooling water circuit in which high-temperature cooling water (in other words, high-temperature heat medium) circulates in the order of the high temperature pump 12, the heater core 17 and the high temperature radiator 19, the condenser 15, and the high temperature pump 12. The cooling water in the high-temperature cooling water circuit C2 flows in parallel through the heater core 17 and the high temperature radiator 19.

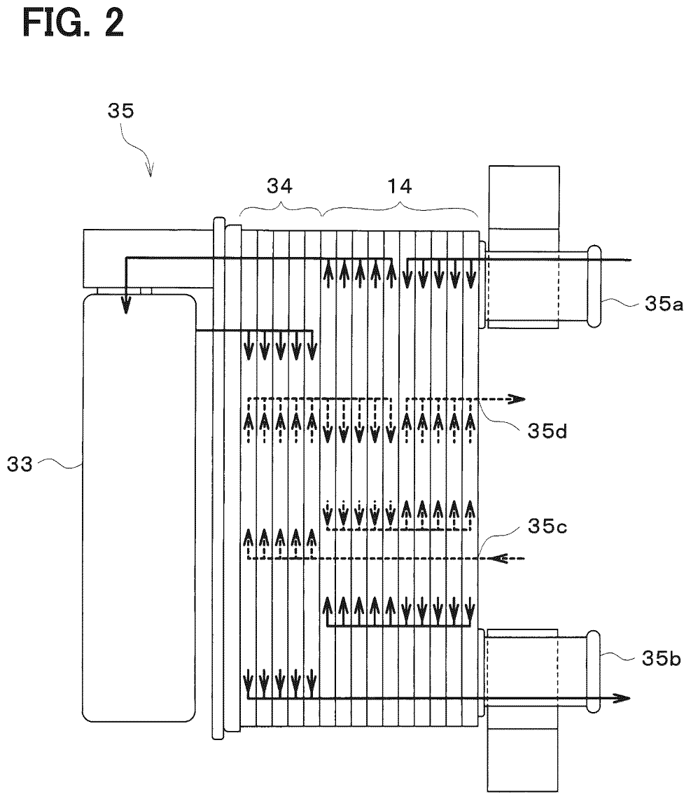

As shown in FIG. 2, the evaporator 14, the accumulator 33, and the superheater 34 are integrated to form a heat exchanger unit 35.

Portions of the heat exchanger unit 35 that form the evaporator 14 and the superheater 34 are stacked heat exchangers. That is, the portions of the heat exchanger unit 35 has a number of metal plate-like members. The number of plate-like members are stacked on top of each other, and a refrigerant flow path and a cooling water flow path are formed between the plate-like members.

The heat exchanger unit 35 has a refrigerant inlet 35a, a refrigerant outlet 35b, a cooling water inlet 35c, and a cooling water outlet 35d. The refrigerant inlet 35a is the common refrigerant inlet for the evaporator 14, the accumulator 33, and the superheater 34. The refrigerant outlet 35b is the common refrigerant outlet for the evaporator 14, the accumulator 33, and the superheater 34. The cooling water inlet 35c is the common cooling water inlet for the evaporator 14, the accumulator 33, and the superheater 34. The cooling water outlet 35d is the common cooling water outlet for the evaporator 14, the accumulator 33, and the superheater 34.

In FIG. 2, solid arrows indicate the refrigerant flow in the refrigerant flow path. In FIG. 2, dashed arrows indicate the coolant water flow in the cooling water flow path. The refrigerant flowing in from the refrigerant inlet 35a flows through the evaporator 14, then flows into the accumulator 33 for gas-liquid separation, and the separated gas-phase refrigerant flows through the superheater 34 and out from the refrigerant outlet 35b. The cooling water flows in from the cooling water inlet 35c, flows through the superheater 34 and the evaporator 14 in series, and flows out from the cooling water outlet 35d.

In the refrigerant flow path of the evaporator 14, the refrigerant flow makes a U-turn. In the cooling water flow path of the evaporator 14, the cooling water flow makes a U-turn. In the evaporator 14 and the superheater 34, flow directions of the refrigerant and the cooling water are opposite each other. In other words, in the evaporator 14 and the superheater 34, a flow of the refrigerant and a flow of the cooling water are opposite each other.

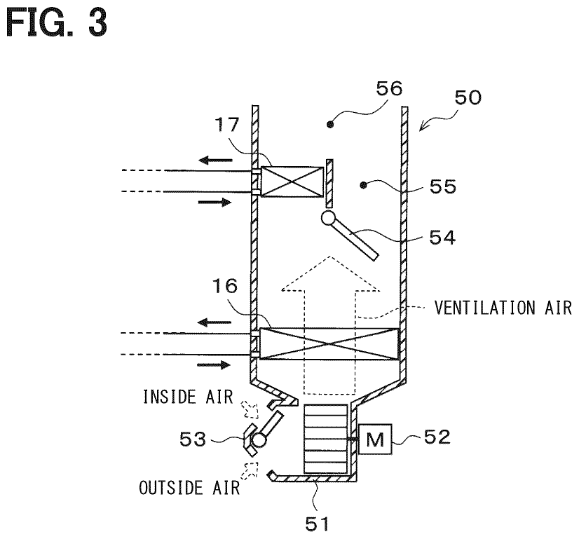

Next, a inside air conditioning unit 50 will be described with reference to FIG. 3. The inside air conditioning unit 50 is a unit in which components are integrated in order to blow out a ventilation air, a temperature of which has been adjusted to an appropriate temperature for air conditioning the vehicle compartment, to an appropriate place in the vehicle compartment. The inside air conditioning unit 50 is disposed inside an instrument panel at a forefront of the vehicle compartment.

An inside air conditioning unit 50 has an air conditioning case forming an air passage in the air conditioning case. The air conditioning case 51 accommodates an indoor blower 52, the cooler core 16, and the heater core 17. The air conditioning case 51 is formed by resin (for example, polypropylene) having a certain degree of elasticity and excellent strength.

An inside-outside air switch device 53 is disposed on the most air flow upstream side of the air conditioning case 51. The inside-outside air switch device 53 switches and introduces an inside air (air within the vehicle compartment) and an outside air into the air conditioning case 51. Operation of the inside-outside air switch device 53 is controlled by a control signal output from the controller 60.

The indoor blower 52 is disposed downstream of the airflow of the inside-outside air switch device 53. The indoor blower 52 is an air blower unit that blows air sucked through the inside-outside air switch device 53, toward the vehicle compartment. The number of rotation (i.e., blowing capability) of the indoor blower 52 is controlled by a control voltage output from the controller 60.

The cooler core 16 and the heater core 17 are located downstream of the airflow of the indoor blower 52. The cooler core 16 is located upstream of the airflow of the heater core 17. A cold-air bypass passage 55 in which the air after passing through the cooler core 16 flows while bypassing the heater core 17 is formed in the air conditioning case 51.

In the air conditioning case 51, an air mix door 54 is arranged downstream of the airflow of the cooler core 16, and upstream of the airflow of the heater core 17 and the cold-air bypass passage 55.

The air mix door 54 regulates a volume ratio between air caused to pass through the heater core 17 and air caused to pass through the cold-air bypass passage 55 in the air having passed through the cooler core 16. Operation of an actuator for driving the air mix door 54 is controlled by a control signal output from the controller 60.

Thus, in the inside air conditioning unit 50, an amount of heat exchange between the refrigerant and the air in the heater core 17 can be changed by changing an opening degree of the air mix door 54.

A mixing space 56 is arranged downstream of the airflow of the heater core 17 and the cold-air bypass passage 55. The mixing space 56 is a space for mixing air heated by the heater core 17 and air not heated by passing through the cold-air bypass passage 55.

Therefore, in the inside air conditioning unit 50, a temperature of the air (that is, a conditioned air) mixed in the mixing space 56 and blown into the vehicle compartment can be adjusted by adjusting the opening degree of the air mix door 54.

Opening holes, which is not shown, for blowing conditioned air toward various positions in the vehicle compartment is formed in an air flow most downstream portion of the air conditioning case 51. A blowing mode door, which is not shown, that opens and closes each opening hole is disposed in each of the opening holes. Operation of an actuator for driving the blowing mode door is controlled by a control signal output from the controller 60.

Therefore, in the inside air conditioning unit 50, by switching the openings which are open/closed by the blowing mode door, the air-conditioned air which is adjusted to a proper temperature can be blown to proper places in the vehicle compartment.

Next, a controller of the present embodiment will be described with reference to a block diagram of FIG. 4. The controller 60 includes a known microcontroller including central processing device (i.e., CPU), a read only memory (i.e., ROM), a random access memory (i.e., RAM), and peripheral circuits. The controller 60 performs various calculations and processes based on a control program stored in the ROM. The controller 60 controls operation of various output side devices to be controlled based on the calculation and processing results.

A group of sensors for control is connected to an input side of the controller 60, including an inside air temperature sensor 61a, an outside air temperature sensor 61b, a insolation sensor 61c, a refrigerant temperature pressure sensor 62 on a high pressure side, a cooling water temperature sensor 63 on a low temperature side, a cooling water temperature sensor 64 on the high temperature side, and a conditioned air temperature sensor 65.

The inside air temperature sensor 61a is an internal air temperature detection unit that detects a vehicle compartment temperature Tr (hereinafter, referred to as the inside air temperature). The outside air temperature sensor 61b is an outside air temperature detection unit that detects a vehicle exterior temperature Tam (hereinafter, referred to as the outside air temperature). The insolation sensor 61c is an insolation amount detector that detects an insolation amount entering the vehicle compartment.

The high-pressure refrigerant temperature pressure sensor 62 is a high-pressure refrigerant temperature and pressure detection unit detecting a high-pressure refrigerant temperature T1 and a high-pressure refrigerant pressure P1 of the refrigerant which is made to outflow from the condenser 15. The low-temperature cooling-water temperature sensor 63 is a low temperature heat medium temperature detection unit that detects the low temperature cooling water temperature TWL, which is a temperature of the cooling water flowing into the cooler core 16.

The high-temperature cooling-water temperature sensor 64 is a high temperature heat medium temperature detection unit that detects the high temperature cooling water temperature TWH, which is a temperature of the cooling water flowing into the heater core 17.

The conditioned air temperature sensor 65 is a conditioned-air temperature detector that detects an air temperature TAV sent from the mixing space 56 into the vehicle compartment.

An operation panel 69 is connected to the input side of the controller 60. The operation panel 69 is located near the instrument panel at the front of the vehicle compartment, and the operation panel 69 is equipped with various operation switches operated by occupants. The controller 60 receives input of operation signals from the various operation switches.

Specific examples of the various operation switches provided on the operation panel 69 include an automatic switch, an air conditioner switch, a heating switch, an air volume setting switch, a temperature setting switch, and the like.

The automatic switch is an automatic control setting unit that sets or cancels automatic control operation of the vehicle air-conditioning device 10. The air conditioner switch is a cooling request unit that requests the cooler core 16 to cool down the conditioned air. The heating switch is a heating request unit that requests the heater core 17 to heat the conditioned air. The air volume setting switch is an air volume setting unit that manually sets an air blowing volume of the indoor blower 52. The temperature setting switch is a temperature setting portion for setting a set temperature Tset of the vehicle compartment.

The controller 60 of the present embodiment is integrally configured with a control unit that controls various control target devices connected to an output side of the controller 60. Therefore, a configuration (hardware and software) that controls the operation of each device to be controlled constitutes a controller that controls the operation of each device to be controlled.

Next, the operation of the vehicle air-conditioning device 10 of the present embodiment with the above configuration will be described. In the vehicle air-conditioning device 10 of the present embodiment, various operation modes are switched in order to perform air conditioning of the vehicle compartment. Switching of the operation mode is performed by executing a control program stored in advance in the controller 60.

The control program is executed when a start switch (so-called ignition switch) of a vehicle system is turned on and the vehicle system is activated.

In the control program, a detection signal of the control sensor group and the operation signal of the operation panel 69 described above are read. A target air outlet temperature TAO, which is a target temperature of the air blown into the vehicle compartment, is calculated on the basis of the read detection signal and operation signal. An operation mode is selected on the basis of the detection signal, the operation signal, the target air outlet temperature TAO, and the like, and the operations of the various control target devices are controlled according to the selected operation mode.

Thereafter, until an end condition of the control program is satisfied, a control routine such as reading of the detection signal and the operation signal, calculation of the target air outlet temperature TAO, selection of the operation mode, and control of various control target devices is repeated every predetermined control cycle.

The target air outlet temperature TAO is calculated by the following formula F1.

TAO=Kset×Tset−Kr×Tr−Kam×Tam−Ks×As+C (formula F1)

“Tset” is a set temperature in the vehicle compartment set by the temperature setting switch. “Tr” is an inside air temperature detected by the inside air temperature sensor 61a. “Tam” is an outside air temperature detected by the outside air temperature sensor 61b. “As” is a solar radiation amount detected by the insolation sensor 61c. “Kset”, “Kr”, “Kam”, and “Ks” are control gains, and “C” is a constant for correction. Each operation mode will be described below.

### (a) Cooling Mode

A cooling mode is an operation mode for cooling the vehicle compartment by blowing the cooled-down air into the vehicle compartment. The cooling mode is selected when the outside air temperature Tam is relatively high or when the target air outlet temperature TAO is a relatively low value in a state where the automatic switch and the air conditioner switch are turned on.

In the cooling mode, the controller 60 controls speed of the compressor 31 so that a temperature TWL of the cooling water at the inlet of the cooler core 16 becomes a target cooling water temperature, and controls an opening of the expansion valve 32 so that a supercooling degree SC1 of the refrigerant heat exchanged in the condenser 15 becomes a target supercooling degree SCO.

The controller 60 sets a target temperature TCO of the cooler core 16 based on a target air outlet temperature TAO. For example, the target cooler core blowout temperature TCO is calculated to decrease as the target air outlet temperature TAO decreases.

For example, a supercooling degree SC1 of the refrigerant heat exchanged in the condenser 15 can be calculated from the high pressure refrigerant temperature T1 and the high pressure refrigerant pressure P1 detected by the high pressure refrigerant temperature pressure sensor 62. The target supercooling degree is determined to cause a coefficient of performance (COP) of the cycle to approach a maximum value.

In the cooling mode, the controller 60 controls the flow control valve 20 so that the cooling water in the high-temperature cooling water circuit C2 flows mainly to the high temperature radiator 19 and the flow rate of the cooling water required for air heating flows to the heater core 17. For example, the flow control valve 20 is controlled based on a deviation between the air temperature TAV detected by the conditioned air temperature sensor 65 and the target air outlet temperature TAO.

In the cooling mode, the controller 60 controls the switching valve 18 so that the cooling water in the low-temperature cooling water circuit C1 flows to the cooler core 16.

The controller 60 controls a rotation speed of the indoor blower 52 based on the target air outlet temperature TAO by reference to a control map stored in advance in the controller 60.

The controller 60 adjusts the opening degree of the air mix door 54 so that the air temperature TAV detected by the conditioned air temperature sensor 65 approaches the target air outlet temperature TAO. The controller 60 appropriately controls the operations of other control target devices.

In the inside air conditioning unit 50 in the cooling mode, the air blown from the indoor blower 52 is cooled down by the cooler core 16. The air cooled by the cooler core 16 is reheated by the heater core 17 according to the opening of the air mix door 54. The air whose temperature has been adjusted so as to approach the target air outlet temperature TAO is blown into the vehicle compartment, thereby implementing to cooling of the vehicle compartment.

### (b) Heating Mode

A heating mode is an operation mode for heating the vehicle compartment by blowing heated ventilation air into the vehicle compartment. The heating mode is selected when the outside air temperature Tam is relatively low or when the target air outlet temperature TAO is relatively high in a state where the automatic switch is turned on.

In the heating mode, the controller 60 controls the speed of the compressor 31 so that a temperature TWH of the cooling water at the inlet of the heater core 17 becomes a target cooling water temperature, and controls the opening of the expansion valve 32 so that the supercooling degree SC1 of the refrigerant heat exchanged in the condenser 15 becomes the target supercooling degree SCO. The target supercooling degree is determined to cause the coefficient of performance (COP) of the cycle to approach the maximum value.

In the heating mode, the controller 60 controls the flow control valve 20 so that the cooling water in the high-temperature cooling water circuit C2 flows toward the heater core 17.

In the heating mode, the controller 60 controls the switching valve 18 so that the cooling water in the low-temperature cooling water circuit C1 flows to the low temperature radiator 13.

The controller 60 controls the rotation speed of the indoor blower 52 based on the target air outlet temperature TAO by reference to the control map stored in advance in the controller 60.

In the inside air conditioning unit 50 in the heating mode, the controller 60 controls the rotation speed of the indoor blower 52 and the opening degree of the air mix door 54 in the same way as in the cooling mode. Furthermore, the controller 60 appropriately controls the operations of the other control target devices.

In the inside air conditioning unit 50 in the heating mode, the air blown from the indoor blower 52 passes through the cooler core 16. The air passing through the cooler core 16 is heated by the heater core 17 according to the opening degree of the air mix door 54. The air whose temperature has been adjusted so as to approach the target air outlet temperature TAO is blown into the vehicle compartment, thereby implementing to heating of the vehicle compartment.

Next, operation with the above configuration will be described. The refrigerant circulates in the refrigeration cycle 30, and the cooling water circulates in the low-temperature cooling water circuit C1 and the high-temperature cooling water circuit C2, respectively, when the low temperature pump 11, the high temperature pump 12, and the compressor 31 are operated.

In the evaporator 14, the refrigerant in the refrigeration cycle 30 absorbs heat from the cooling water in the low-temperature cooling water circuit C1. The refrigerant absorbed in the evaporator 14 dissipates heat to the cooling water in the high-temperature cooling water circuit C2 in the condenser 15. As a result, the cooling water in the high-temperature cooling water circuit C2 is heated.

The cooling water in the low-temperature cooling water circuit C1, cooled by the evaporator 14, absorbs heat from the outside air at the low temperature radiator 13.

The cooling water in the low-temperature cooling water circuit C1, cooled by the evaporator 14, absorbs heat from the air blown from the indoor blower 52 in the cooler core 16. In other words, the air blown from the indoor blower 52 is cooled by the cooler core 16.

The cold air cooled by the cooler core 16 flows into the heater core 17 and the cold-air bypass passage 55, depending on the opening degree of the air mix door 54.

The cold air that flows into the heater core 17 is heated by the cooling water in the high-temperature cooling water circuit C2 heated by the condenser 15 as it passes through the heater core 17, and is mixed with the cold air that has passed through the cold-air bypass passage 55 in the mixing space 56.

Then, the conditioned air whose temperature has been regulated in the mixing space 56 is blown into the vehicle compartment from the mixing space 56 through each of the opening holes in the air conditioning case 51.

The vehicle compartment is cooled when the internal temperature in the vehicle compartment is lower than the outside temperature due to the conditioned air blown into the vehicle compartment. The vehicle compartment is heated when the internal temperature in the vehicle compartment is higher than the outside temperature due to the conditioned air blown into the vehicle compartment.

The refrigerant that has absorbed heat from the cooling water in the low-temperature cooling water circuit C1 and evaporated in the evaporator 14 is separated from the gas-liquid in the accumulator 33. The refrigerant in the gas-phase separated in the accumulator 33 flows into the superheater 34 and exchanges heat with the cooling water in the low-temperature cooling water circuit C1.

Since the cooling water in the low-temperature cooling water circuit C1 flowing into the superheater 34 is hotter than the refrigerant flowing out of the accumulator 33, the refrigerant in the gas-phase is superheated at the superheater 34 by heat absorption from the cooling water in the low-temperature cooling water circuit C1.

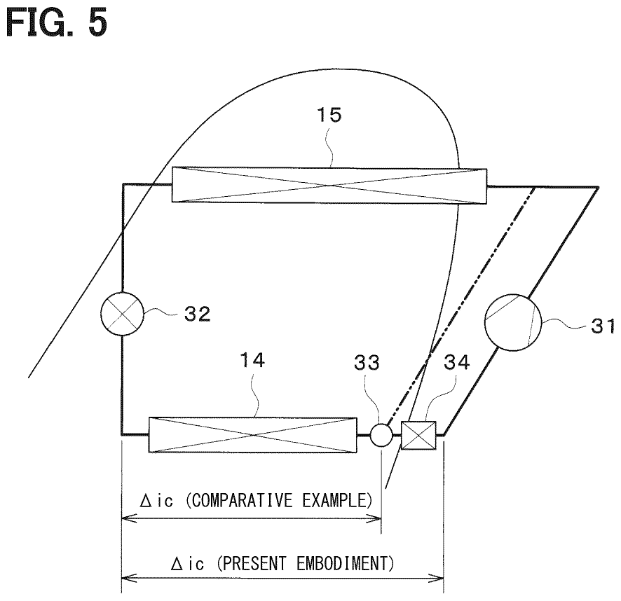

In a Mollier diagram (enthalpy-entropy chart) in FIG. 5, solid lines show the change of state of the refrigerant in the present embodiment, and a two-dot chain line shows the change of state of the refrigerant in a comparative example. The comparative example differs from the present embodiment in that it is not equipped with the superheater 34.

The Mollier diagram in FIG. 5 shows that an enthalpy difference Δic at low pressure (i.e., the enthalpy difference at the evaporator 14 and the superheater 34) is larger than in the comparative example because the refrigerant is superheated in the gas-phase in the superheater 34 in the present embodiment. Therefore, the cycle performance (so-called COP) is improved compared to the comparative example.

The present embodiment has the superheater 34 that superheats the refrigerant flowing out of the accumulator 33 by exchanging heat with a heat medium hotter than the refrigerant flowing out of the accumulator 33.

According to this, the refrigerant flowing out of the accumulator 33 is superheated in the superheater 34, thereby increasing the enthalpy difference at the low pressure, i.e., in the evaporator 14 and the superheater 34. Therefore, the cycle performance can be improved.

The present embodiment has the cooler core 16 that cools the air by exchanging heat between the cooling water and the air, and the evaporator 14 evaporates the refrigerant, which is depressurized by the expansion valve 32, by exchanging heat with the cooling water. As a result, the superheater 34 can be easily installed since the refrigerant exchanges heat with the same heat medium as each other in the evaporator 14 and the superheater 34. Therefore, the cycle performance can be easily improved.

In the present embodiment, the flow direction of the refrigerant and the flow direction of the cooling water are opposite each other in the superheater 34. As a result, the refrigerant can be effectively superheated in the superheater 34.

In the present embodiment, the evaporator 14, the superheater 34, and the accumulator 33 consist of a single heat exchanger unit 35 having a common refrigerant inlet 35a, a common refrigerant outlet 35b, a common cooling water inlet 35c, and a common cooling water outlet 35d. As a result, the superheater 34 can be installed in a simple configuration.

### Second Embodiment

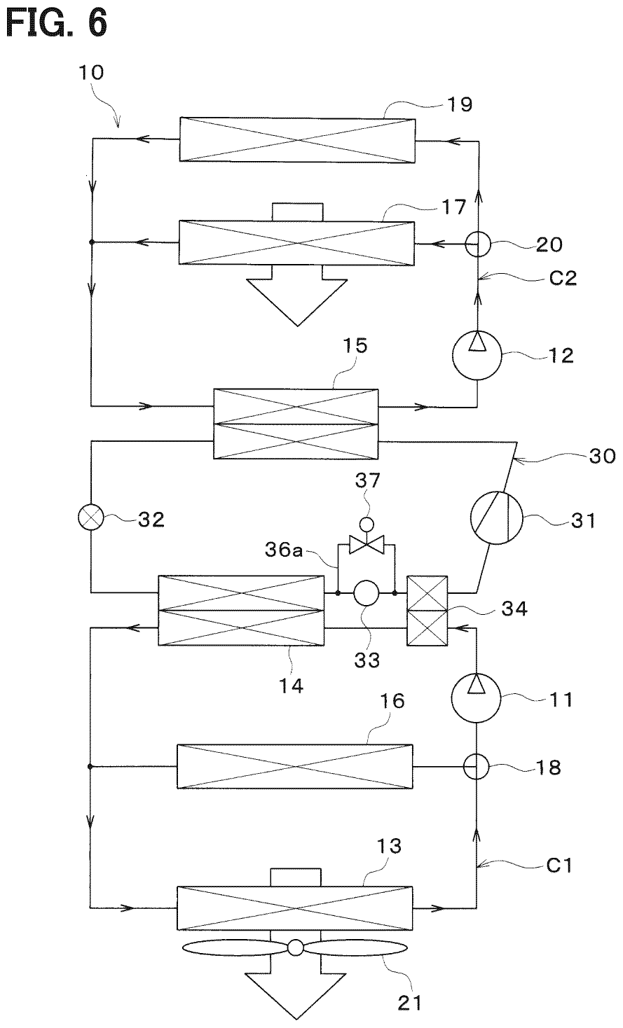

In a second embodiment, as shown in FIG. 6, a vehicle air-conditioning device 10 is equipped with a bypass flow path 36a and a bypass valve 37 between an evaporator 14 and a superheater 34. The bypass flow path 36a is a refrigerant flow path where refrigerant flowing out of the evaporator 14 bypasses an accumulator 33 and flows to the superheater 34. The bypass valve 37 is a solenoid valve that opens and closes the bypass flow path 36a.

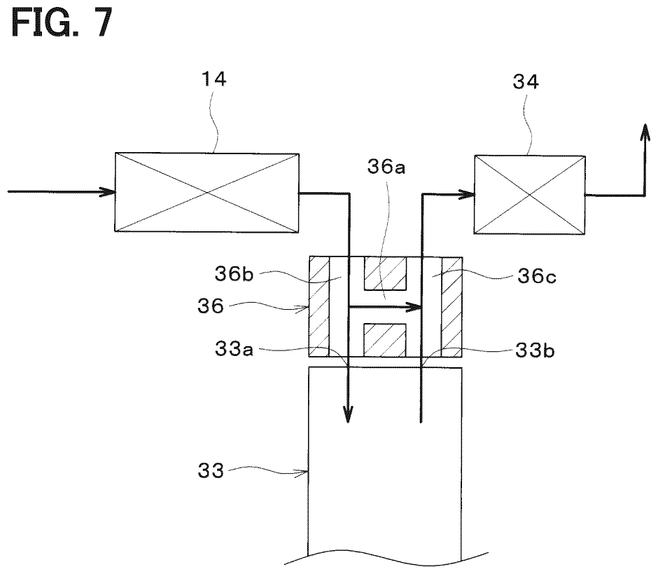

As shown in FIG. 7, the bypass flow path 36a is formed in a bypass forming member 36. The bypass forming member 36 is a bypass forming part that forms the bypass flow path 36a. The bypass forming member 36 is attached to the accumulator 33.

The bypass forming member 36 has an inlet flow path 36b and an outlet flow path 36c. The inlet flow path 36b is a flow path that leads refrigerant flowing out of the evaporator 14 to a refrigerant inlet 33a of the accumulator 33. The outlet flow path 36c is a flow path that leads the refrigerant flowing out of a refrigerant outlet 33b of the accumulator 33 to the superheater 34.

The bypass flow path 36a connects the inlet flow path 36b with the outlet flow path 36c. The bypass valve 37 is located inside the bypass forming member 36. In FIG. 7, the bypass valve 37 is omitted for convenience of illustration.

The operation of the bypass valve 37 is controlled by a controller 60. The refrigerant flowing out of the evaporator 14 does not flow into the bypass flow path 36a but into the accumulator 33 when the bypass valve 37 is closed. The refrigerant flowing out of the evaporator 14 flows in parallel with the bypass flow path 36a and the accumulator 33 when the bypass valve 37 is open.

A refrigerant flow ratio between the bypass flow path 36a and the accumulator 33 when the bypass valve 37 is open is, for example, 1:1.

For example, the controller 60 opens the bypass valve 37 when a discharge flow rate (in other words, refrigerant discharge capacity) of the compressor 31 exceeds a predetermined flow rate (in other words, predetermined capacity), and closes the bypass valve 37 when the discharge flow rate of the compressor 31 is below the predetermined flow rate.

As a result, the flow of the refrigerant to the accumulator 33 is blocked when the flow rate of the refrigerant circulating through the refrigeration cycle 30 is high, thereby reducing refrigerant pressure loss and improving the cycle performance. On the other hand, the flow of the refrigerant to the bypass flow path 36a can be blocked to ensure that the refrigerant flows into the accumulator 33 when the flow rate of the refrigerant circulating through the refrigeration cycle 30 is low.

In the second embodiment, the bypass valve 37 is not necessarily provided, and the refrigerant flowing out of the evaporator 14 may always flow in parallel to the bypass flow path 36a and the accumulator 33 without the bypass valve 37.

### Third Embodiment

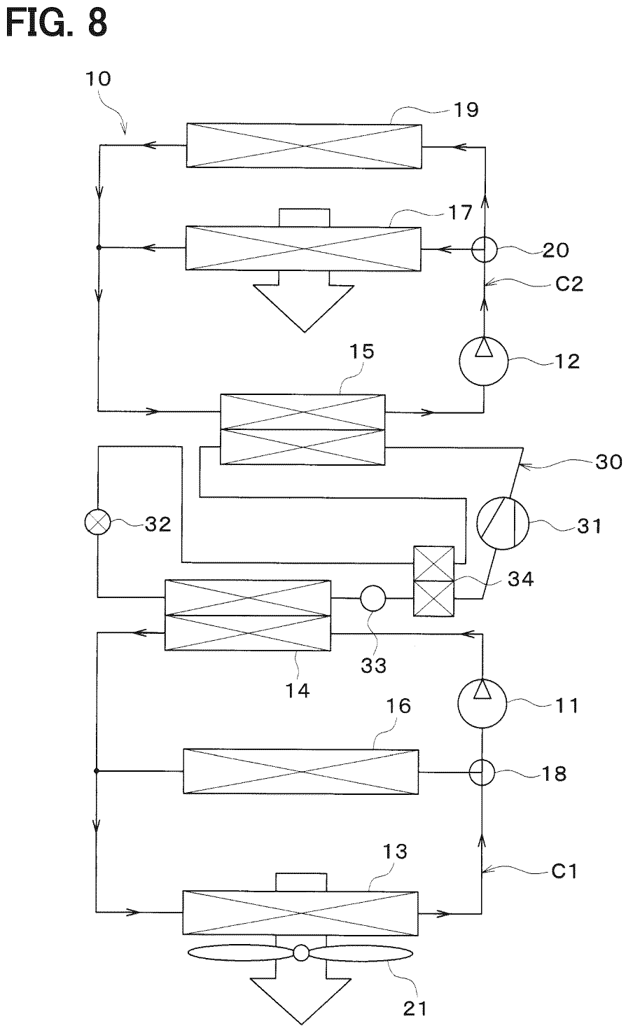

In the above embodiment, the superheater 34 is a heat exchanger which superheats the vapor-phase refrigerant flowing out of the accumulator 33 by exchanging heat with the cooling water, but in a third embodiment, as shown in FIG. 8, a heat exchanger superheats the refrigerant by exchanging heat with the refrigerant which is hotter than the refrigerant discharged from the accumulator 33.

In the present embodiment, as in the above embodiment, the cycle performance COP can be improved by superheating the refrigerant flowing out of the accumulator 33 in the superheater 34.

The present disclosure is not limited to the above-described embodiments, and can be variously modified as follows within the scope that does not deviate from the gist of the present disclosure.

The above-described embodiments may be combined with each other to meet requirements. The above-described embodiments may be variously modified as follows, for example.

In the above embodiments, the cooling water is used as the heat medium flowing through the low-temperature cooling water circuit C1 and the high-temperature cooling water circuit C2, but various media such as oil may be used as heat medium. Ethylene glycol-based antifreeze, water, or air maintained above a certain temperature may be used as heat medium. A nanofluid may be used as the heat medium. A nanofluid is a fluid in which nanoparticles having a particle diameter on the order of nanometers are mixed.

In the refrigeration cycle 30 in the above-described embodiments, a fluorocarbon refrigerant is used as the refrigerant. However, the refrigerant may not be limited to being the fluorocarbon refrigerant. A natural refrigerant such as carbon dioxide or a hydrocarbon refrigerant may be used.

The refrigeration cycle 30 in each of the above embodiments forms a subcritical refrigeration cycle in which the high-pressure-side refrigerant pressure does not exceed the critical pressure of the refrigerant. However, the refrigeration cycle 30 may form a supercritical refrigeration cycle in which the high-pressure-side refrigerant pressure exceeds the critical pressure of the refrigerant.

In the above embodiments, the vehicle air-conditioning device 10 is applied to the electric vehicle. However, the vehicle air-conditioning device 10 may also be applied to a hybrid vehicle that obtains driving power for vehicle driving from an engine (internal combustion engine) and an electric motor for driving. For example, a hybrid vehicle may be configured as a plug-in hybrid vehicle that charges a battery mounted to the vehicle with power supplied from an external power source while the vehicle is stationary.

In the above embodiments, the refrigeration cycle 30 is used in the vehicle air-conditioning device 10 that adjusts the vehicle compartment to an appropriate temperature, but the refrigeration cycle 30 may also be used in a vehicle-mounted equipment temperature control device that adjusts various vehicle-mounted equipment to an appropriate temperature.

For example, the refrigeration cycle 30 may be used in an on-board battery temperature regulator that adjusts the on-board battery to the appropriate temperature. More specifically, the on-board battery, the evaporator 14, the condenser 15, the cooler core 16, and the heater core 17 may be located in a battery unit casing.

The refrigeration cycle 30 may be used in equipment temperature control devices to adjust various types of equipment (for example, non-vehicle equipment) as well as vehicle-mounted equipment to the appropriate temperature.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A refrigeration cycle device, comprising:
a compressor for drawing a refrigerant and discharging the refrigerant after compressing the refrigerant;
a radiator for dissipating heat from the refrigerant discharged from the compressor;
a decompressor for decompressing the refrigerant after heat dissipation in the radiator;
an evaporator for evaporating the refrigerant after decompression in the decompressor;
an accumulator for performing gas-liquid separation of the refrigerant after evaporation in the evaporator and discharging the refrigerant in a gas-phase;
a superheater for superheating the refrigerant discharged from the accumulator by performing heat exchange with a heat medium that is hotter than the refrigerant discharged from the accumulator;
a cooling heat exchanger for cooling an object to be cooled by performing heat exchange between the heat medium and the object; and
a heat medium circuit formed so that the heat medium circulates through the evaporator, the superheater and the cooling heat exchanger, wherein
the evaporator evaporates the refrigerant after decompression in the decompressor by performing heat exchange with the heat medium.

2. A refrigeration cycle device, comprising:
a compressor for drawing a refrigerant and discharging the refrigerant after compressing the refrigerant;
a radiator for dissipating heat from the refrigerant discharged from the compressor;
a decompressor for decompressing the refrigerant after heat dissipation in the radiator;
an evaporator for evaporating the refrigerant after decompression in the decompressor;
an accumulator for performing gas-liquid separation of the refrigerant after evaporation in the evaporator and discharging the refrigerant in a gas-phase; and
a superheater for superheating the refrigerant discharged from the accumulator by performing heat exchange with a heat medium that is hotter than the refrigerant discharged from the accumulator, wherein
the evaporator, the superheater, and the accumulator are constituted by a heat exchanger unit having a common refrigerant inlet, a common refrigerant outlet, a common heat medium inlet and a common heat medium outlet.

3. The refrigeration cycle device according to claim 2, further comprising
a cooling heat exchanger for cooling an object to be cooled by performing heat exchange between the heat medium and the object, wherein
the evaporator evaporates the refrigerant after decompression in the decompressor by performing heat exchange with the heat medium.

4. The refrigeration cycle device according to claim 2, wherein
a flow direction of the refrigerant and a flow direction of the heat medium in the superheater are opposite to each other.

5. The refrigeration cycle device according to claim 1, further comprising:
a bypass forming member for defining a bypass flow path through which the refrigerant that has evaporated in the evaporator bypasses the accumulator;
a bypass valve for opening and closing the bypass flow path; and
a controller configured to open the bypass valve when refrigerant discharge capacity of the compressor exceeds predetermined capacity, and to close the bypass valve when the refrigerant discharge capacity is below the predetermined capacity.
